(19) United States
(12) Patent Application Publication
(10) Pub. No.: US 2026/0352910 A1
(43) Pub. Date: Nov. 5, 2026

(54) PREDICTIVE CONTENT DISTRIBUTION SYSTEM

(71) Applicant: DISH Network L.L.C., Englewood, CO (US)

(72) Inventors: Aakash Kotha, Denver, CO (US); Vineet Parsai, Denver, CO (US); Rajesh Makala, Liberty Hill, TX (US)

(21) Appl. No.: 19/197,737

(22) Filed: May 2, 2025

(51) Int. Cl. H04N 21/258; G06N 20/20; H04N 21/25

(52) U.S. Cl. CPC H04N 21/25883; G06N 20/20; H04N 21/251

(57) ABSTRACT

A method for predicting content distribution platform usage is provided herein. The method includes obtaining user interaction data associated with a content distribution platform and obtaining demographic data. The method further includes generating a first propensity model based on the user interaction data and the demographic data, wherein the first propensity model predicts a likelihood of subscription to the content distribution platform. Additionally, the method includes generating a second propensity model based on the user interaction data and the demographic data, wherein the second propensity model predicts a likelihood of subscription to the content distribution platform for a predetermined time period. The method also includes identifying influential features of the first propensity model and the second propensity model, and generating a target user profile based on the identified influential features.

### BACKGROUND

Content delivery platforms have become increasingly prevalent in the digital age, offering users access to a wide variety of media and entertainment options. These platforms typically provide on-demand access to content such as streaming video, music, podcasts, and e-books. Video streaming services may offer movies, television shows, and original programming, while music streaming platforms provide access to vast libraries of songs and albums. Some platforms focus on specific content types, such as audiobooks or educational materials.

Subscription-based models are common among content delivery platforms, where users pay a recurring fee for access to the platform's content library. Subscriber churn, which refers to the rate at which customers cancel or discontinue their subscriptions, presents technical challenges for these platforms. Churn may occur for various reasons, including changes in user preferences, competition from other platforms, or seasonal viewing patterns. Content delivery platforms experiencing high churn rates often face technical infrastructure difficulties such as inefficient resource allocation, where pre-cached content may go unused, leading to wasted storage space and unnecessary data transfer costs. Additionally, platforms may struggle with network traffic management when subscriber behavior patterns change rapidly, potentially causing congestion during peak viewing times or underutilized capacity during off-peak hours. These technical challenges can impact content delivery quality, system performance, and overall user experience.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Some exemplary embodiments are related to a method comprising obtaining user interaction data associated with a content distribution platform, obtaining demographic data, generating a first propensity model based on the user interaction data and the demographic data, wherein the first propensity model predicts a likelihood of subscription to the content distribution platform, generating a second propensity model based on the user interaction data and the demographic data, wherein the second propensity model predicts a likelihood of subscription to the content distribution platform for a predetermined time period, identifying influential features of the first propensity model and the second propensity model, and generating a target user profile based on the identified influential features.

Other exemplary embodiments are related to a system for predicting future content distribution infrastructure use, comprising a processor and a non-transitory computer readable medium storing instructions that, when executed, cause the system to obtain user interaction data associated with a content distribution platform, obtain demographic data, generate a first propensity model based on the user interaction data and the demographic data, wherein the first propensity model predicts a likelihood of subscription to the content distribution platform, generate a second propensity model based on the user interaction data and the demographic data, wherein the second propensity model predicts a likelihood of subscription to the content distribution platform for a predetermined time period, identify influential features of the first propensity model and the second propensity model, generate a target user profile based on the identified influential features, and identify a target user population based on the target user profile to predict future content distribution platform activity.

Still further exemplary embodiments are related to a non-transitory computer-readable medium storing instructions that are executable to obtain user interaction data associated with a content distribution platform, obtain demographic data, generate a first propensity model based on the user interaction data and the demographic data, wherein the first propensity model predicts a likelihood of subscription to the content distribution platform, generate a second propensity model based on the user interaction data and the demographic data, wherein the second propensity model predicts a likelihood of subscription to the content distribution platform for a predetermined time period, identify influential features of the first propensity model and the second propensity model, and generate a target user profile based on the identified influential features.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a content distribution system, in accordance with aspects of the described technology.

FIG. 2 illustrates a flowchart of a method for predicting content distribution platform usage, in accordance with aspects of the described technology.

FIG. 3 illustrates a flowchart of a method for generating and applying propensity models, in accordance with aspects of the described technology.

FIG. 4 illustrates a flowchart of a method for updating subscription models, in accordance with aspects of the described technology.

FIGS. 5A-5E illustrate graphs depicting relationships between model features and SHAP values, in accordance with aspects of the described technology.

FIG. 6 illustrates a block diagram of a system with interconnected components, in accordance with aspects of the described technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Although the examples described herein may be presented in the context of a video streaming platform, the disclosed technology may be implemented with any content delivery platform. For instance, the described systems and methods may be applied to music streaming services, where subscribers have access to vast libraries of songs and albums. As another example, the technology may be utilized by video game platforms, where subscribers can access and download various games from a curated collection. The propensity models and target user profiling techniques may be adapted to predict subscription likelihood and duration for these different types of content delivery platforms, potentially improving resource allocation and user retention across diverse media ecosystems.

Content distribution platforms may face technical challenges related to resource provisioning due to subscriber churn. Subscriber churn occurs when subscribers cancel or discontinue their subscriptions to a service within a specific time period, typically measured over intervals such as 30 days, 90 days, 5 months, 7 months, or up to a year in some cases. Common examples include subscribers who sign up only for a sports season and then cancel once the season ends, subscribers who join to watch a specific series and unsubscribe after completing it, subscribers who take advantage of free trial periods with no intention of continuing service, and subscribers who switch between competing platforms based on rotating content catalogs. Frequent subscriber turnover may lead to inefficient resource allocation, such as pre-caching content that few users will access, resulting in wasted storage space and unnecessary data transfer costs. Content distribution platforms may over-provision edge servers in geographic regions where subscriber retention is low, leading to underutilized hardware. Network traffic management may become more complex when subscriber behavior patterns change rapidly due to churn, potentially causing congestion during peak viewing times or unnecessary capacity during off-peak hours. Pre-caching popular content at edge servers may become less effective when viewer preferences shift rapidly. Content delivery networks (CDNs) may implement adaptive caching algorithms using machine learning techniques to adjust to changing viewer populations, but these systems may require stable user bases to function effectively. Accurately identifying viewers likely to maintain long-term subscriptions may enable improved technical resource provisioning by allowing content distribution platforms to optimize infrastructure deployment for those customers most likely to interact with future provided resources. For example, content distribution platforms may implement geographic-specific content caching strategies using cloud-based content delivery services or edge computing platforms based on regions with high concentrations of predicted long-term subscribers, or utilize elastic computing resources that automatically scale based on real-time demand patterns and predicted usage trends.

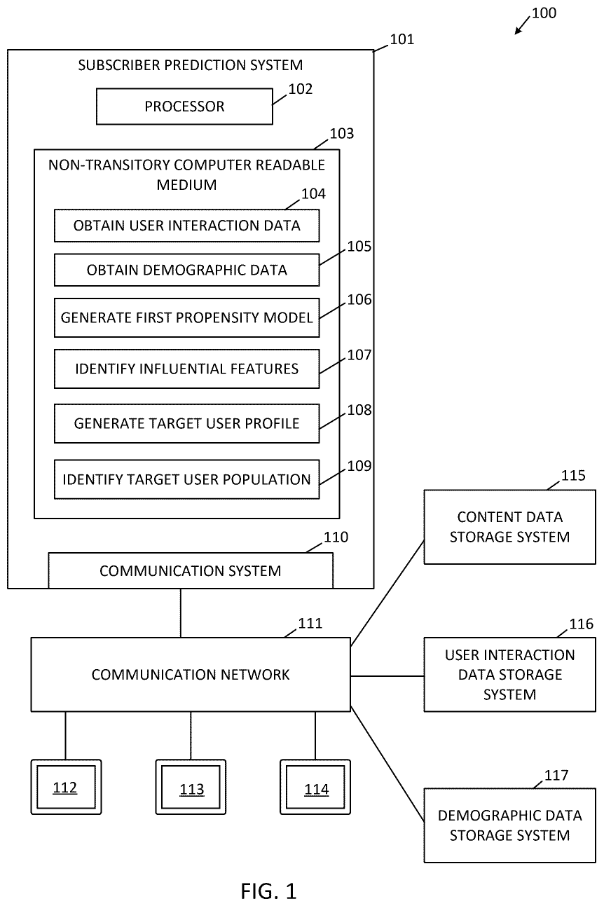

FIG. 1 illustrates a content distribution system 100 for delivering media content to subscribers and generating target user profiles. The content distribution system 100 may include a subscriber analysis system 101 that analyzes user data to generate target user profiles, a communication network 111 facilitating data exchange between system components, client devices 112, 113, and 114 used by subscribers to access content, and a content storage system 115 that maintains media files for distribution. For example, the subscriber analysis system 101 may be implemented using cloud-based computing resources. For instance, the communication network 111 may utilize fiber optic infrastructure or cellular technology. For example, the client devices 112, 113, and 114 may include smart televisions, streaming media players, mobile devices, etc. For instance, the content storage system 115 may be implemented using distributed storage technologies. In some cases, the content distribution system 100 may employ adaptive bitrate streaming protocols.

The subscriber analysis system 101 analyzes user data and generates target user profiles. The system identifies patterns that indicate characteristics of ideal users for the platform. For example, the subscriber analysis system 101 may implement feature engineering pipelines that transform raw viewing data into meaningful profile variables such as content genre preferences, viewing time patterns, engagement metrics, etc. In some cases, the subscriber analysis system 101 may employ ensemble methods that combine multiple model outputs. For instance, the subscriber analysis system 101 may implement machine learning algorithms including gradient boosted decision trees to process historical viewing patterns and demographic information, with optimized hyperparameters such as tree depth, learning rate, regularization settings, etc.

The subscriber analysis system 101 may be configured to provision content distribution infrastructure resources based on the identified target user population. This provisioning may include allocating bandwidth, storage capacity, or processing power to support predicted content consumption patterns of the target user population.

The content distribution system 100 may include a streaming platform that delivers live TV channels and on-demand content to subscribers over the internet. The streaming platform may deliver video at appropriate quality levels based on network conditions and device capabilities.

The content storage system 115 stores media files and associated metadata for distribution to subscribers. For example, the content storage system 115 may include storage area networks (SANs), network-attached storage (NAS) systems, content delivery networks (CDNs), object storage systems, cloud storage platforms, etc. For instance, the content storage system 115 may utilize distributed file systems, redundant array of independent disks (RAID) configurations, solid-state drive (SSD) arrays, etc. For example, the content storage system 115 may include edge caching servers, content repositories, media asset management systems, distributed database clusters, etc.

The communication network 111 facilitates data transfer between components of the content distribution system 100 and may comprise various examples. For instance, the communication network 111 may include the Internet, enterprise networks, content distribution networks. For example, the first client device 112, second client device 113, and third client device 114 may be used by subscribers to access content provided by the content distribution system 100. These client devices may include smart TVs, streaming media players, mobile phones, tablets.

Subscribers may obtain content from the content storage system 115 through the communication network 111, generating user interaction data during this process. This interaction data may include quantifiable metrics. For example, the interaction data may include viewing duration, content selection patterns, viewing time distributions, device type usage patterns, etc. For instance, the content distribution system 100 may implement event tracking using a time-series database that records timestamped interaction events. In some cases, the system may collect session-level metrics including buffering events, quality switches, exit points, etc. For example, the system may employ anonymized user identifiers that maintain consistent tracking across devices. The system may collect and analyze this interaction data to improve content recommendations and inform target user profile generation.

The interaction storage system 116 may connect to the communication network 111 to store user interaction data related to subscribers' content consumption patterns and platform usage. The interaction storage system 116 may store various types of interaction data obtained from client devices and content delivery systems. For example, the interaction storage system 116 may be implemented using time-series databases such as InfluxDB, Prometheus, or TimescaleDB. The interaction data stored in the interaction storage system 116 may include viewing duration, content selection patterns, viewing time distributions, device type usage patterns, buffering events, quality switches, exit points, engagement metrics, binge-watching patterns, content discovery pathways, and session-level metrics. In some cases, the interaction storage system 116 may implement data partitioning strategies based on time ranges or user segments. The interaction storage system 116 may utilize columnar storage formats such as Apache Parquet or Apache ORC. For instance, the interaction storage system 116 may employ data encryption and anonymization techniques. The subscriber analysis system 101 may obtain user interaction data from the interaction storage system 116. For example, instructions may be executed to implement event tracking using a client-side library embedded in client applications that captures user interactions with timestamps. In some cases, the processor 102 may execute instructions to utilize server-side logging of content delivery network requests to capture viewing events even when client-side tracking is unavailable. For example, instructions may be executed to employ session stitching algorithms that reconstruct continuous viewing sessions from discrete interaction events across multiple devices.

The demographic storage system 117 may connect to the communication network 111 to store demographic data related to subscribers, past subscribers, and potential subscribers. The demographic storage system 117 may store various types of demographic data obtained from first-party sources and third-party providers such as Epsilon, TransUnion, or other data aggregation services. For example, the demographic storage system 117 may be implemented using distributed database technologies such as Apache Cassandra, MongoDB, or Amazon DynamoDB. The demographic data stored in the demographic storage system 117 may include age distributions, income levels, geographic location information, household composition details, home ownership status, urbanicity classifications indicating rural versus urban locations, high-definition television penetration rates, designated market areas (DMAs), education levels, occupation types, internet availability indicators, number of cable providers in an area, and custom segmentation categories provided by third-party vendors. In some cases, the demographic storage system 117 may implement data partitioning strategies based on geographic regions. The demographic storage system 117 may utilize columnar storage formats such as Parquet or ORC. For instance, the demographic storage system 117 may employ data encryption and tokenization techniques. The subscriber analysis system 101 may obtain demographic data from the demographic storage system 117. Instructions may be executed to utilize third-party data providers that aggregate demographic information from multiple sources including public records, surveys, consumer databases, etc. In some cases, instructions may be executed to implement privacy-preserving data enrichment techniques that match user identifiers to demographic attributes using secure hashing and matching algorithms. For example, the processor 102 may execute instructions to employ geographic information systems that associate location data with demographic characteristics based on census block groups or zip code tabulation areas.

The subscriber analysis system 101 may include a processor 102 and a non-transitory computer readable medium 103. For example, the processor 102 may be implemented using hardware suitable for machine learning workloads, including central processing units, graphics processing units, accelerators, etc. In some cases, the processor 102 may implement field-programmable gate arrays programmed with custom logic for specific machine learning operations. For instance, the processor 102 may utilize distributed computing frameworks that coordinate workloads across multiple processing nodes using message passing interface protocols. The subscriber analysis system 101 may include a communication system 110, such as a network interface card (NIC), etc. to connect to the communication network 111.

The non-transitory computer readable medium 103 may include various examples. For instance, the non-transitory computer readable medium 103 may include random access memory (RAM), read-only memory (ROM), flash memory, solid-state drives (SSDs), hard disk drives (HDDs), optical storage media, magnetic storage devices, cache memory, non-volatile memory express (NVMe) drives, storage area networks (SANs), network-attached storage (NAS), redundant array of independent disks (RAID) configurations, cloud storage platforms, distributed file systems, removable storage media, etc.

The non-transitory computer readable medium 103 may contain user interaction data instructions 104. Instructions 104 may be executed to implement data extraction and transformation procedures. For example, instructions 104 may implement query templates for database interaction, data processing pipelines for extract, transform, load operations. For instance, the processor 102 may execute the user interaction data instructions 104 to utilize workflow orchestration tools for managing complex data processing workflows with dependency management and scheduling capabilities. In some cases, instructions 104 may be executed to implement stream processing frameworks for real-time analysis of user interaction events. For example, the processor 102 may execute the user interaction data instructions 104 to employ data validation libraries that enforce schema constraints and detect anomalies in incoming interaction data. For instance, these operations may be implemented using data processing libraries.

The subscriber analysis system 101 may execute the user interaction data instructions 104 to process and analyze the obtained user interaction data. Instructions 104 may be executed to implement algorithms for calculating engagement metrics. For example, instructions 104 may calculate average viewing session duration, content completion rates, binge-watching patterns, content discovery pathways, etc. For instance, instructions 104 may be executed to utilize time-windowed aggregation functions that compute rolling averages of engagement metrics over different time periods to identify trends. In some cases, the processor 102 may execute the user interaction data instructions 104 to implement sequence mining algorithms that identify common viewing patterns across user populations. For example, instructions 104 may be executed to employ anomaly detection techniques that identify unusual changes in viewing behavior that might indicate changing preferences or user characteristics for profile development.

The demographic data instructions 105 may be stored in the non-transitory computer readable medium 103. Instructions 105 may be executed to implement procedures for demographic data processing. The demographic data may include various attributes. For example, the demographic data may include age distributions, income levels, geographic location information, household composition details, home ownership status, etc. For instance, instructions 105 may be executed to utilize third-party data providers that aggregate demographic information from multiple sources including public records, surveys, consumer databases, etc. In some cases, the processor 102 may execute the demographic data instructions 105 to implement privacy-preserving data enrichment techniques that match user identifiers to demographic attributes using secure hashing and matching algorithms. For example, instructions 105 may be executed to employ geographic information systems that associate location data with demographic characteristics based on census block groups or zip code tabulation areas. For instance, these operations may be implemented using statistical imputation techniques for handling missing data, one-hot encoding for categorical variables like urbanicity, multiple imputation techniques for generating plausible values for missing data points, binning strategies that transform continuous variables like age and income into discrete categories, etc.

The subscriber analysis system 101 may execute the demographic data instructions 105 to process and integrate the obtained demographic data. Instructions 105 may be executed to implement routines for data processing. For example, instructions 105 may implement routines for normalizing numerical variables, encoding categorical variables, handling missing data, feature engineering, etc. For instance, instructions 105 may be executed to utilize one-hot encoding for categorical variables like urbanicity to create binary feature vectors suitable for machine learning algorithms. In some cases, the processor 102 may execute the demographic data instructions 105 to implement multiple imputation techniques that generate several plausible values for missing data points. For example, instructions 105 may be executed to employ binning strategies that transform continuous variables like age and income into discrete categories based on domain knowledge or statistical distribution properties. For instance, these operations may include statistical imputation techniques for handling missing data.

The non-transitory computer readable medium 103 may store propensity model generation instructions 106. Instructions 106 may be executed to implement techniques for creating predictive propensity models that identify potential subscribers that are likely to remain subscribed for a threshold amount of time. For example, the threshold amount of time may include 6 or 7 months up to a year or more. The predetermined time period may be selected based on business profitability analysis, where subscription revenue exceeds customer acquisition costs after a specific duration. In some implementations, the predetermined time period may be configured as a hyperparameter during model training, allowing operators to adjust the target subscription duration from 3 months to 12 months depending on business objectives and market conditions. For instance, the system may implement a grid search across different time period values (e.g., 5, 7, 9, and 11 months) to identify the optimal prediction window that maximizes model performance metrics such as AUC-ROC or F1 score. In other cases, the predetermined time period may be determined through statistical analysis of historical viewing data, identifying natural breakpoints in the subscription duration distribution where significant changes in retention patterns occur. For example, analysis of subscriber lifecycle data might reveal that customers who maintain subscriptions beyond 7 months have a 78% probability of continuing for at least 18 months.

The first propensity model may predict the likelihood of subscription to the content distribution platform by analyzing patterns in demographic data and user interaction data. For instance, the first propensity model may incorporate feature interactions through tree structures that capture non-linear relationships between variables such as geographic location, income levels, content preferences. When generating the first propensity model, the subscriber analysis system 101 may train a first decision tree model on a population comprising subscribers and non-subscribers using the obtained demographic data and the obtained user interaction data. The system may then evaluate model performance by comparing predicted subscribers against actual subscribers in a validation dataset.

The second propensity model may specifically predict the likelihood of maintaining a subscription for a predetermined time period. For example, the predetermined time period may include six months, seven months, nine months, or longer. The model may incorporate temporal features derived from viewing patterns, such as engagement consistency, content diversity metrics, and seasonal viewing behaviors. The processor 102 may execute the propensity model generation instructions 106 to implement automated machine learning techniques that systematically explore model architectures and hyperparameter configurations. Instructions 106 may employ ensemble methods that combine predictions from both propensity models using techniques such as weighted averaging and probability blending. The propensity model generation instructions 106 may also implement model validation techniques including cross-validation and time-based validation splits. The subscriber analysis system 101 may project viewership data for non-customers based on neighborhood-level information by analyzing viewing patterns and engagement rates within specific zip codes or census blocks. This projected data serves as input features for the propensity models. Further examples and details of these techniques are described below.

For the second propensity model, the subscriber analysis system 101 may train a second decision tree model on the obtained user interaction data and the obtained demographic data, with the user interaction data including content viewing patterns. The performance of this model may be evaluated by comparing predicted long-term subscribers against actual long-term subscribers in a validation dataset.

The feature identification instructions 107 may be stored in the non-transitory computer readable medium 103. The processor 102 may execute the feature identification instructions 107 to implement techniques to identify influential features for target user profiles. For example, instructions 107 may be executed to implement tree interpreter algorithms that analyze decision paths in gradient boosted tree models to quantify feature contributions. In some cases, instructions 107 may be executed to utilize integrated gradients methods for attributing predictions from neural network models to specific input features. For instance, the processor 102 may execute the feature identification instructions 107 to employ local interpretable model-agnostic explanations that approximate complex models with simpler, interpretable models around specific prediction instances. The feature identification instructions 107 may be executed to calculate Shapley Additive Explanations (SHAP) values for the first propensity model to determine which features contribute most significantly to subscription likelihood predictions. In some implementations, the processor 102 may execute the feature identification instructions 107 to implement feature ablation studies where features are systematically removed from both propensity models to measure the resulting performance impact. The feature identification instructions 107 may be executed to calculate feature interaction strengths using H-statistics to identify pairs of features in both propensity models that jointly influence predictions more than their individual contributions would suggest. For example, these operations may be implemented using feature importance analysis techniques including Shapley Additive Explanations value calculations, permutation importance methods, partial dependence plots, etc.

To refine the models and identify factors influencing subscriber behavior, the subscriber analysis system 101 may analyze the second propensity model to identify influential features based on their impact on predicting long-term subscribers. This process may involve ranking the identified influential features, selecting a subset of the ranked influential features, and generating the target user population by applying the selected subset of influential features to a potential subscriber population. The subscriber analysis system 101 may utilize Shapley Additive Explanations (SHAP) values for features of the first or second propensity model to identify influential features.

The non-transitory computer readable medium 103 may store profile generation instructions 108. Instructions 108 may be executed to implement techniques for creating target user profiles based on the influential features identified from both the first propensity model and the second propensity model. For example, the processor 102 may execute the profile generation instructions 108 to analyze the identified influential features and determine value ranges for each feature that correlate with high subscription likelihood and extended subscription duration. In some cases, instructions 108 may be executed to implement threshold determination algorithms that identify specific demographic attribute values, such as income levels above $50,000 or age ranges between 39-69, that appear most frequently in long-term subscribers. For instance, the processor 102 may execute the profile generation instructions 108 to employ feature importance weighting techniques that prioritize features with stronger predictive power when constructing the target profile, giving greater emphasis to features that demonstrate consistent importance across both propensity models. For example, these operations may be implemented using various clustering algorithms including K-means clustering, hierarchical clustering, density-based spatial clustering of applications with noise, etc., which may group potential subscribers based on similarity across the identified influential features. For instance, the profile generation instructions 108 may implement ensemble clustering methods that combine multiple clustering results. The target user profile may be structured as a JSON object with key-value pairs representing influential features and their optimal ranges, such as {“age_range”: [39, 69], “income_min”: 50000, “household_size_min”: 2, “home_ownership”: “definite_owner”, “location_types”: [“urban”, “suburban”, “rural”], etc. The non-transitory computer readable medium 103 may store the target user profile in a document-oriented database, relational database, etc.

The population identification instructions 109 may be stored in the non-transitory computer readable medium 103. Instructions 109 may be executed to implement procedures for identifying target populations based on generated user profiles. For example, instructions 109 may be executed to implement distributed query execution engines that optimize complex filtering operations across partitioned datasets stored in columnar formats. In some cases, the processor 102 may execute the population identification instructions 109 to utilize approximate query processing techniques that provide rapid results with statistical guarantees for large-scale population identification tasks. For instance, instructions 109 may be executed to employ probabilistic data structures for efficient set membership testing when filtering large user populations. For example, these operations may be implemented using database query operations and large-scale data filtering procedures, utilizing structured query language for relational database queries, NoSQL query languages for document databases, distributed computing frameworks for processing large datasets, etc.

The decision tree models used in the first and second propensity models may be implemented as gradient boosted decision tree models. The process of generating these models may include iteratively training multiple decision trees to correct errors of previous trees, combining predictions from the multiple decision trees to form ensemble models, and optimizing the ensemble models using a gradient descent algorithm to minimize a loss function.

The subscriber analysis system 101 may implement automated retraining triggers for the propensity models. For instance, the system may continuously monitor model performance metrics and automatically initiate retraining when performance drops below a predetermined threshold, such as a 15% decrease in prediction accuracy. Additionally, the system may trigger retraining when significant changes in business offerings occur, such as the introduction of new content packages or pricing structures.

To maintain the effectiveness of the propensity models, the subscriber analysis system 101 may be configured to monitor performance metrics of both models over time. If the system detects that a performance metric falls below a predetermined threshold, it may automatically retrain at least one of the propensity models using updated user interaction data and demographic data.

The subscriber analysis system 101 may also be designed to adapt to changes in the content distribution platform's offerings. For instance, the system may detect a change in content offerings, such as the addition of new channels or on-demand content. In response, the system may generate a dashboard displaying current performance metrics of both propensity models. This dashboard can be presented to system operators, who can then provide input indicating whether a retraining decision should be made based on the displayed metrics. If retraining is deemed necessary, the system can initiate the process using the most current user interaction data available.

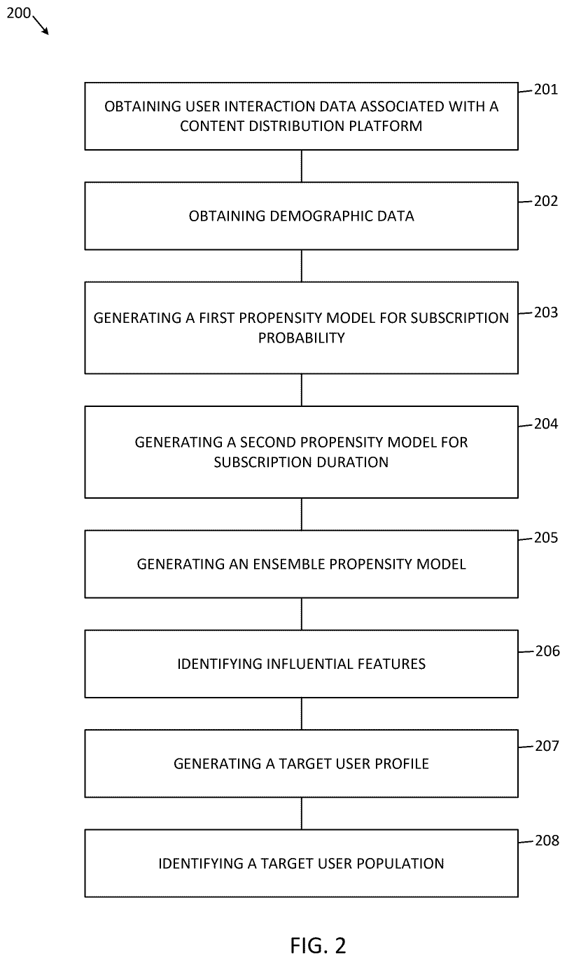

FIG. 2 illustrates a flowchart of a method 200 for predicting content distribution platform usage. For example, the method 200 may be implemented by the subscriber analysis system 101. The method 200 may be performed by one or more computers executing instructions stored on a non-transitory computer readable medium, such as the non-transitory computer readable medium 103 shown in FIG. 1. For example, the processor 102 of the subscriber analysis system 101 may execute instructions to perform the steps of the method 200. In some implementations, multiple computing devices may work together to perform the method 200, with different steps being performed by different devices in a distributed computing environment.

A step 201 of the method 200 may include obtaining user interaction data associated with a content distribution platform. For example, step 201 may include executing user interaction data instructions to retrieve viewing history, engagement metrics, and content preferences from an interaction storage system. Step 201 may include recording real-time viewing events as subscribers interact with content, such as tracking play, pause, and content completion events through client-side event tracking libraries embedded in streaming applications. For instance, step 201 may include server-side logging of content delivery network requests to capture viewing events even when client-side tracking is unavailable. Step 201 may include obtaining existing viewership data including viewing duration, content selection patterns, viewing time distributions, device type usage patterns, buffering events, quality switches, exit points, engagement metrics, binge-watching patterns, content discovery pathways, and session-level metrics. In some cases, step 201 may include processing raw interaction data to generate derived metrics, such as calculating average viewing session duration, content completion rates, or creating engagement scores that compare individual viewing patterns against platform-wide averages for specific time periods. For example, step 201 may include time-windowed aggregation functions that compute rolling averages of engagement metrics over different time periods to identify trends. Step 201 may include transforming interaction data through feature engineering pipelines that convert raw viewing data into meaningful profile variables such as content genre preferences, viewing time patterns, and engagement metrics. The user interaction data may be stored in time-series databases such as InfluxDB or TimescaleDB. For example, the raw interaction data may be structured using JSON or Avro formats for flexible schema representation, while processed metrics may be stored in columnar storage formats like Apache Parquet or Apache ORC. In some cases, the feature engineering pipelines may be implemented using data processing frameworks such as Apache Spark or Apache Beam, with intermediate data transformations stored in distributed file systems like Hadoop Distributed File System (HDFS). The engagement scores and derived metrics may be maintained in relational database tables with appropriate indexing strategies, potentially using PostgreSQL with TimescaleDB extension. Step 201 may incorporate projected viewership data for non-customers based on neighborhood-level or demographic cluster information. For example, step 201 may include analyzing viewing patterns within specific zip codes or census blocks to estimate potential engagement levels for non-subscribers in those areas. This projected data may be generated using spatial analysis techniques such as kriging or inverse distance weighting to interpolate viewership patterns across geographic regions.

A step 202 may include obtaining demographic data. For example, step 202 may include executing demographic data instructions to retrieve demographic information from a demographic storage system. Step 202 may include obtaining demographic data through user registration forms, surveys, or third-party data providers such as Epsilon or TransUnion. The demographic data may include age distributions, income levels, geographic location information, household composition details, home ownership status, urbanicity classifications, high-definition television penetration rates, designated market areas (DMAs), education levels, occupation types, internet availability indicators, number of cable providers in an area, and custom segmentation categories. Step 202 may include implementing data processing techniques such as statistical imputation for handling missing data, one-hot encoding for categorical variables, and binning strategies for continuous variables (e.g., age, income, etc.). The demographic data may be structured using columnar storage formats such as Apache Parquet or Apache ORC. In some cases, step 202 may include utilizing geographic information systems to associate location data with demographic characteristics based on census block groups or zip code tabulation areas. The demographic storage system may be implemented using columnar storage formats such as Apache Parquet or Apache ORC. For example, the demographic data may be structured using a star schema database architecture with a central fact table containing household identifiers linked to dimension tables for various demographic attributes. The demographic data processing pipeline may utilize extract, transform, load (ETL) workflows implemented with Apache Airflow or similar workflow orchestration tools.

A step 203 may involve generating a first propensity model based on the user interaction data and the demographic data, wherein the first propensity model predicts a likelihood of subscription to the content distribution platform. For example, step 203 may include executing propensity model generation instructions to train a gradient boosted decision tree model using features derived from both interaction and demographic data. The gradient boosted decision tree model may be implemented using open-source machine learning libraries such as XGBoost, LightGBM, or CatBoost that provide implementations of gradient boosting algorithms. The first propensity model may be trained on a population comprising both current subscribers and non-subscribers to identify patterns that distinguish potential subscribers from unlikely prospects. For instance, step 203 may include a binary classification approach where subscribers are labeled as positive examples and non-subscribers as negative examples. The training process may involve iteratively building multiple decision trees, with each subsequent tree focusing on correcting errors made by previous trees. The decision trees in the gradient boosted model may be constructed using a recursive partitioning approach that splits the feature space based on information gain or variance reduction metrics, creating a hierarchical structure of decision nodes that progressively refine predictions as data flows from the root node to the leaf nodes.

Step 203 may include optimizing hyperparameters such as learning rate, tree depth, and regularization settings through cross-validation techniques. The learning rate hyperparameter may control how aggressively each tree corrects the errors of the ensemble, with smaller values typically requiring more trees. Tree depth hyperparameters may limit the maximum number of sequential splits allowed in each decision tree. Regularization hyperparameters such as minimum child weight and L1/L2 penalties may help control model complexity. Feature engineering for the first propensity model may include transforming raw demographic attributes into more predictive variables, such as binning continuous variables like income into discrete categories or creating interaction terms between related features like geographic location and internet availability. Step 203 may include implementing feature selection techniques to identify the most predictive variables, potentially using methods such as recursive feature elimination or permutation importance. For demographic data, the first propensity model may incorporate attributes including age distributions, income levels, household composition, urbanicity classifications, and third-party segmentation categories. From user interaction data, the first propensity model may utilize features such as content selection patterns, viewing durations, device usage, and engagement metrics for existing subscribers, while projecting these values for non-subscribers based on neighborhood-level or demographic cluster information. The gradient boosted decision tree model may handle non-linear relationships between features and target variables without requiring explicit feature transformations, as the tree structure naturally partitions the feature space into regions with similar response values.

The first propensity model may generate probability scores ranging from 0 to 1, indicating the likelihood of an individual subscribing to the content distribution platform, with higher scores representing greater subscription probability. The gradient boosted decision tree model may produce these probability scores by aggregating predictions from all trees in the ensemble, with each tree contributing a partial prediction that is weighted by the learning rate. Step 203 may include evaluating the model's performance using metrics such as area under the receiver operating characteristic curve (AUC), precision, recall, and lift scores. The AUC metric may quantify the model's ability to rank positive examples higher than negative examples across all possible threshold values, providing a threshold-independent measure of discriminative power. Step 203 may include implementing threshold optimization techniques to determine a probability cutoff for classifying potential subscribers based on business objectives. For deployment, step 203 may include implementing the model within a prediction pipeline capable of scoring millions of potential subscribers, potentially utilizing distributed computing frameworks for large-scale prediction tasks. The gradient boosted decision tree model may be serialized into a compact format that enables inference on various computing platforms, from server clusters to edge devices. The model's tree structure may also facilitate interpretability through feature importance analysis.

When training the first propensity model, step 203 may include dividing available data into three distinct sets: training, validation, and testing. For example, the training set may comprise 70% of the data, with validation and testing sets each allocated 15%. The training set may be used to fit the model parameters through iterative optimization processes such as gradient descent. The validation set may be utilized during the training process to tune hyperparameters and prevent overfitting by implementing early stopping when validation performance plateaus or degrades. The testing set, completely isolated from the training process, may provide an evaluation of the final model's performance on unseen data. For making predictions on a potential subscriber population, step 203 may include applying the trained first propensity model to demographic and projected interaction data for individuals not currently subscribed to the content distribution platform. The model may generate probability scores for each potential subscriber, which may then be ranked from highest to lowest probability. Step 203 may include validating these predictions by comparing a subset of predicted subscribers against actual subscription outcomes over time. For instance, the system may track individuals identified as high-probability subscribers and monitor whether these individuals actually subscribe to the platform within a specified timeframe, such as 30, 60, or 90 days. This validation process may involve calculating confusion matrix metrics including true positive rate (individuals correctly predicted to subscribe who actually subscribed) and false positive rate (individuals incorrectly predicted to subscribe who did not subscribe). The validation results may be used to calculate lift scores by comparing the subscription rate among high-probability individuals to the baseline subscription rate in the general population. For example, if the baseline subscription rate is 2% and the rate among the top decile of predicted subscribers is 9%, the model would demonstrate a lift of 4.5× for this segment. Step 203 may include implementing time-based validation approaches where predictions are made at one point in time and outcomes are observed over subsequent periods.

A step 204 may involve generating a second propensity model based on the user interaction data and the demographic data, wherein the second propensity model predicts a likelihood of subscription to the content distribution platform for a predetermined time period. For example, step 204 may include executing propensity model generation instructions to train a gradient boosted decision tree model as discussed with respect to step 203, but with a focus on features that correlate with long-term retention. The second propensity model may be trained on a population comprising subscribers who have maintained subscriptions for various durations, with those maintaining subscriptions for the predetermined time period labeled as positive examples and those canceling earlier labeled as negative examples. The training process may involve similar iterative tree building as described in step 203, but with optimization targets specifically focused on retention prediction accuracy.

The step 204 may include optimizing hyperparameters for the second propensity model using techniques similar to those described in step 203, but potentially with different parameter ranges tailored to retention prediction. For example, the learning rate for the second model may be set between 0.01 and 0.3, with smaller values often yielding more robust long-term prediction performance. Tree depth hyperparameters may be constrained between 3 and 10 levels to balance complexity with generalization ability for retention patterns. The cross-validation process for the second model may use 5 folds with stratified sampling to ensure balanced representation of long-term and short-term subscribers across all folds. For example, the hyperparameter optimization may be implemented using Bayesian optimization techniques that efficiently explore the parameter space by modeling the relationship between hyperparameter settings and validation performance. The Bayesian optimization approach may utilize Gaussian processes to model the objective function and acquisition functions such as expected improvement to guide the search toward promising regions of the parameter space.

Feature engineering for the second propensity model may include creating temporal variables that capture subscription behavior patterns over time. For example, viewing consistency metrics may be derived to quantify how regularly subscribers engage with content, calculated as coefficients of variation in daily or weekly viewing minutes. Content diversity indices may be implemented using entropy-based measures across content categories, where higher entropy values represent more diverse viewing patterns that may correlate with longer retention. Seasonal viewing patterns may be extracted using time-series decomposition techniques such as Seasonal-Trend decomposition using LOESS (STL) to identify cyclical engagement behaviors that might predict long-term subscription intent. For instance, the STL decomposition may separate viewing data into trend, seasonal, and residual components, with the seasonal component potentially revealing cyclical patterns tied to specific content releases or viewing habits. The second propensity model may incorporate ratio features comparing individual viewing patterns to demographic cluster averages, potentially revealing subscribers whose behavior deviates significantly from their demographic peers in ways that predict retention. For example, a subscriber who watches significantly more documentary content than the average for their demographic segment might exhibit different retention characteristics.

The second propensity model may incorporate content-specific features that reflect subscriber engagement with particular types of programming. For example, the proportion of viewing time dedicated to episodic content versus event-based programming may be analyzed, with higher engagement with episodic content potentially indicating longer-term subscription intent. The content-specific features may include completion rates for series content, measuring what percentage of available episodes subscribers watch to completion. Binge-watching patterns may be quantified through features that track the number of consecutive episodes viewed in single sessions, with higher values potentially correlating with stronger platform engagement. Content discovery pathways may be encoded as features representing how subscribers typically find new content, such as through recommendations, browsing, or search functions. For instance, the content discovery features may be implemented as categorical variables with one-hot encoding, creating binary indicators for each discovery method. Recency-frequency-monetary (RFM) analysis techniques adapted to content consumption may be implemented, where recency measures days since last viewing session, frequency captures viewing session counts within specific time windows, and monetary aspects are represented by engagement with premium or add-on content. For example, exponentially weighted moving averages of these metrics may be calculated using decay factors between 0.1 and 0.3 to give greater importance to recent behavior while still accounting for historical patterns.

The second propensity model may generate probability scores ranging from 0 to 1, indicating the likelihood of a subscriber maintaining their subscription for the predetermined time period. For example, calibration techniques such as Platt scaling or isotonic regression may be implemented to ensure the output probabilities accurately reflect true probabilities rather than just relative rankings. The probability calibration process may involve fitting a logistic regression model to the outputs of the gradient boosted decision tree model using a held-out validation dataset. The calibrated probability scores may be used to segment subscribers into tiers for targeted retention efforts, with different thresholds potentially applied based on business objectives and resource constraints. For instance, the segmentation may create high, medium, and low retention risk categories using probability thresholds determined through profit curve analysis. Threshold optimization techniques may be implemented that consider asymmetric costs between false positives and false negatives, potentially using metrics such as F-beta scores where beta values greater than 1 place more emphasis on recall than precision. For deployment, the second propensity model may be implemented within a real-time scoring system that updates subscriber probability scores as new interaction data becomes available. For example, the real-time scoring system may be built using stream processing technologies such as Apache Kafka and Apache Flink that enable continuous data ingestion and model scoring with low latency. The system may implement a sliding window approach where models are applied to the most recent n days or weeks of interaction data, with older data given progressively less weight in the prediction process through exponential decay functions.

A step 206 may include generating an ensemble propensity model by combining the outputs of the first propensity model and the second propensity model. This combination process may involve techniques such as weighted averaging, where each model's predictions are assigned different weights based on their individual performance metrics. For example, the weighted averaging may be implemented using a linear combination formula where weights are determined through cross-validation on a held-out dataset. In some cases, stacking methods may be employed, using a meta-model trained on the outputs of the first and second models to produce final predictions. For instance, the stacking approach may utilize a logistic regression algorithm as the meta-learner that takes probability outputs from both base models as input features. The ensemble propensity model may leverage the strengths of both constituent models, potentially capturing both short-term subscription likelihood and long-term retention probability. Feature importance scores from both models may be aggregated to provide a comprehensive view of influential factors across the entire customer lifecycle. The ensemble propensity model's performance may be evaluated using cross-validation techniques, comparing its predictive accuracy against that of the individual models. For example, k-fold cross-validation may be implemented (with k=5, for example) to assess model stability and generalization capability across different data partitions. In some implementations, the ensemble propensity model may incorporate additional data sources or models, such as external market indicators or customer service interaction data. For instance, the ensemble approach may include a weighting mechanism that adjusts the relative importance of each base model according to recent performance metrics calculated on a rolling window of validation data.

A step 207 may involve identifying influential features of the first propensity model and the second propensity model. For example, step 207 may include executing feature identification instructions to calculate Shapley Additive Explanations (SHAP) values for each feature in both models. For instance, step 207 may include tree interpreter algorithms that analyze decision paths in gradient boosted tree models to quantify feature contributions. In some cases, step 207 may include utilizing integrated gradients methods for attributing predictions from neural network models to specific input features. Step 207 may include implementing permutation importance techniques that measure feature influence by randomly shuffling feature values and observing the impact on model predictions. For example, step 207 may include local interpretable model-agnostic explanations (LIME) that approximate complex models with simpler, interpretable models around specific prediction instances. The feature identification process may include ranking features based on their absolute SHAP values, with higher absolute values indicating stronger influence on model predictions regardless of direction. For instance, step 207 may include implementing partial dependence plots to visualize how changes in feature values affect model predictions while holding other features constant. Step 207 may include generating feature importance visualizations such as SHAP summary plots, SHAP dependence plots, and SHAP force plots to provide comprehensive insights into feature influences across different segments of the subscriber population.

A step 208 may include generating a target user profile based on the identified influential features. For instance, step 208 may include executing profile generation instructions to create a composite profile of users likely to subscribe and remain subscribed for the predetermined time period. This profile generation process may involve clustering algorithms such as K-means or DBSCAN to group users with similar characteristics. Step 208 may include analyzing the identified influential features and determining optimal value ranges for each feature that correlate with high subscription likelihood and extended subscription duration. For example, the profile might identify specific demographic attributes such as age ranges between 39-69, income levels above $50,000, household sizes of 2 or more people, and home ownership status. The profile generation process may implement threshold determination algorithms that identify specific demographic attribute values that appear most frequently in long-term subscribers. For instance, step 208 may include feature importance weighting techniques that prioritize features with stronger predictive power when constructing the target profile, giving greater emphasis to features that demonstrate consistent importance across both propensity models. In some cases, step 208 may include applying model outputs to a third-party segmentation for expanded targeting. For example, step 208 may include mapping the characteristics of the identified target user population to pre-defined consumer segments provided by a third-party marketing company such as TransUnion, which has segmented the entire US population into 172 distinct segments. This mapping process may utilize machine learning techniques like random forests or support vector machines to classify users into the most appropriate segments based on their attributes and predicted behaviors. Alternatively, the mapping may be performed based on similarity of descriptions between the generated target user profile and the descriptions of the third-party segments. This approach may expand the targetable population, potentially increasing the scale from 15 million to 44 million potential subscribers. The mapping may be validated through market testing to confirm that the identified segments demonstrate the expected subscription and retention behaviors.

A step 209 may involve identifying a target user population based on the target user profile to predict future content distribution platform activity. For example, step 209 may include executing population identification instructions to apply the target user profile to a broader population of potential subscribers. This process may utilize probabilistic data structures like Bloom filters for efficient set membership testing when filtering large user populations. For instance, step 209 may include distributed query execution engines that optimize complex filtering operations across partitioned datasets stored in columnar formats. In some cases, step 209 may include utilizing approximate query processing techniques that provide rapid results with statistical guarantees for large-scale population identification tasks. The target user population may be used to guide marketing efforts, optimize content recommendations, and improve resource allocation. This approach allows for more targeted marketing and retention efforts by focusing on users with a higher likelihood of long-term subscription. Step 209 may include applying model outputs to a third-party segmentation for expanded targeting. For example, step 209 may include mapping the characteristics of the identified target user population to pre-defined consumer segments provided by a third-party marketing company such as TransUnion, which has segmented the entire US population into 172 distinct segments. This mapping process may utilize machine learning techniques like random forests or support vector machines to classify users into the most appropriate segments based on their attributes and predicted behaviors. Alternatively, the mapping may be performed based on similarity of descriptions between the generated target user profile and the descriptions of the third-party segments. This approach may expand the targetable population, potentially increasing the scale from 15 million to 44 million potential subscribers. The mapping may be validated through market testing to confirm that the identified segments demonstrate the expected subscription and retention behaviors.

By implementing the method 200, the content distribution system may identify and target potential long-term subscribers. This approach may lead to more efficient resource allocation and enhanced stability of the platform. For example, by focusing marketing efforts on users with a higher likelihood of long-term subscription, the platform may reduce customer acquisition costs and improve overall profitability. Additionally, more accurate predictions of user behavior may enable better content caching strategies, potentially reducing bandwidth requirements and improving streaming quality for users.

The targeted advertising enabled by the method 200 may improve the stability and predictability of the content distribution platform. By identifying users who are more likely to remain subscribed for extended periods, the platform can allocate marketing resources more effectively and develop content strategies aligned with the preferences of its most valuable customers.

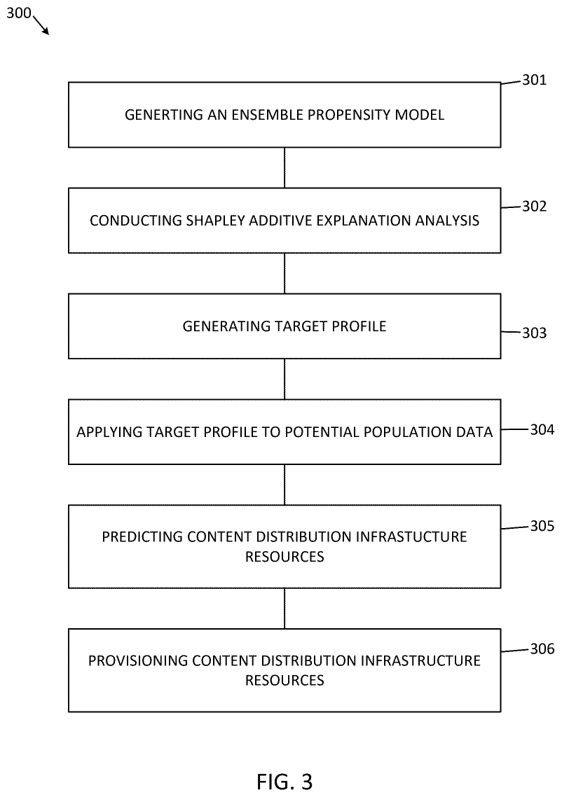

FIG. 3 illustrates a flowchart of a method 300 for generating and applying propensity models. The method 300 may be implemented by the subscriber analysis system 101. The method 300 may be performed by one or more computers executing instructions stored on the non-transitory computer readable medium 103, such as the propensity model generation instructions 106. For example, the processor 102 of the subscriber analysis system 101 may execute instructions to perform the steps of the method 300.

A step 301 of the method 300 may include generating an ensemble propensity model. The ensemble propensity model may comprise a first propensity model and a second propensity model. In some cases, the first propensity model and the second propensity model may be implemented as gradient boosted decision tree models, such as XGBoost gradient boosted decision tree models.

When generating the first propensity model, step 301 may include training a first decision tree model on a population comprising subscribers and non-subscribers using the obtained demographic data and the obtained user interaction data. Model performance may then be evaluated by comparing predicted subscribers against actual subscribers in a validation dataset. For example, the validation dataset may be created using a stratified sampling approach to ensure representative proportions of subscribers and non-subscribers.

For the second propensity model, step 301 may include training a second decision tree model on the obtained user interaction data and the obtained demographic data, with the user interaction data including content viewing patterns. The performance of this model may be evaluated by comparing predicted long-term subscribers against actual long-term subscribers in a validation dataset. For instance, the content viewing patterns may be represented as feature vectors encoding information such as genre preferences, viewing frequency, and average session duration.

The gradient boosted decision tree models may be generated by iteratively training multiple decision trees to correct errors of previous trees. Predictions from the multiple decision trees may be combined to form ensemble models. The ensemble models may then be optimized using a gradient descent algorithm to minimize a loss function. For example, the loss function may be implemented as a binary logistic loss for classification tasks or a mean squared error for regression tasks.

Step 301 may include creating engagement scores relative to average viewership as part of feature engineering. For instance, z-scores for individual viewing durations relative to the population mean may be calculated, providing a standardized measure of engagement across different content types.

Hyperparameter tuning may be performed with respect to model performance. For example, the hyperparameter tuning process may utilize Bayesian optimization techniques implemented using libraries such as Optuna or Hyperopt.

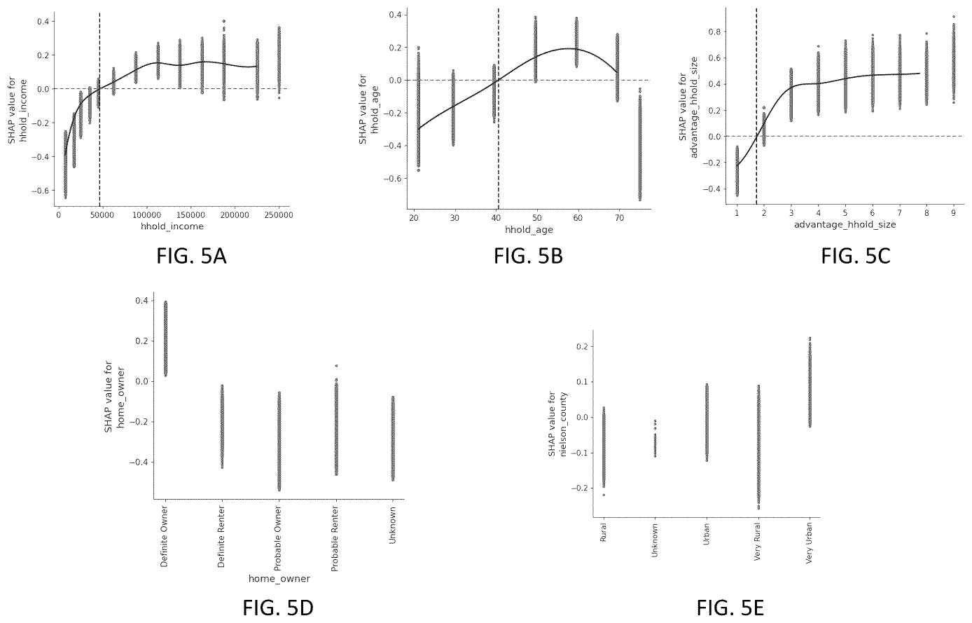

A step 302 of the method 300 may include conducting Shapley additive explanation analysis. This analysis technique may be used to interpret the output of the ensemble propensity model and identify the influential features contributing to the predictions. For example, the SHAP (SHapley Additive exPlanations) library may be used to compute Shapley values for each feature, quantifying their impact on model predictions. The Shapley additive explanation analysis may be derived from cooperative game theory, where each feature may be considered a “player” in a game, and the prediction outcome may be considered the “payout.” The analysis may determine how to fairly distribute the “payout” among the “players” based on their marginal contributions. For instance, the analysis may calculate the average marginal contribution of each feature across all possible feature combinations, considering all permutations of feature inclusion and exclusion. FIGS. 5A-5E illustrate examples of relationships between various features and their corresponding SHAP values. For example, FIG. 5A illustrates how household income may relate to SHAP values, potentially showing a positive relationship that plateaus at higher income levels. The step 302 may include identifying a specific number of top influential features, such as the 20 most important features based on their absolute Shapley values. For example, features may be ranked by their mean absolute SHAP values with selection of the top 20 features with the highest impact on model predictions. In some cases, the step 302 may include determining the number of features through statistical analysis rather than using a predetermined number. For example, an elbow method may be implemented that plots the cumulative importance of features and identifies the point where adding more features provides diminishing returns. FIG. 5B illustrates an example of how age might relate to SHAP values, potentially showing a curved relationship with peaks in certain age ranges. The step 302 may utilize bootstrapping techniques to assess the stability of feature importance rankings across multiple subsamples of the data. For instance, 100 bootstrap samples may be generated, feature importance computed for each sample, and features selected that appear in the top rankings with high frequency. FIG. 5C may demonstrate how household size might relate to SHAP values, potentially showing trends that vary with different household sizes. The step 302 may include visualizing feature importance through SHAP summary plots, which may display both the magnitude and direction of each feature's impact on model predictions. FIGS. 5D and 5E may illustrate examples of how categorical features such as home ownership categories and location-based segments might relate to SHAP values, potentially showing varying impacts across different categories.

A step 303 may include generating a target profile based on the Shapley analysis results. This profile may represent the characteristics of potential subscribers who are most likely to subscribe and maintain subscriptions for a threshold amount of time, such as seven months or longer. For example, step 303 may include mapping the features identified in step 302 to specific value ranges that correlate with long-term subscription behavior. If household income is identified as an important factor in step 302, then step 303 might include determining that an income greater than $75,000 is a value for the profile. Similarly, if age is identified as influential, step 303 may establish that an age range of 35-65 years correlates with extended subscription duration. For instance, step 303 may implement clustering algorithms that group potential subscribers with similar feature values to identify thresholds for each profile attribute. The target profile may be represented as a set of feature-value pairs, with each pair specifying a demographic or behavioral characteristic and its associated value range that indicates higher likelihood of long-term subscription. For example, the target profile may be implemented as a JSON structure containing key-value pairs for each influential feature, or as a vector of feature importance scores with associated threshold values. Step 303 may include validating the generated profile against a holdout dataset.

A step 304 may include applying the target profile to potential population data. This step may involve using the generated profile to identify individuals within a larger population who match the characteristics of ideal subscribers. For example, the application of the target profile may be implemented as a similarity scoring function that computes the distance between individual user profiles and the target profile in a high-dimensional feature space.

A step 305 may include predicting content distribution infrastructure resources based on the application of the target profile. This prediction may take into account the expected subscription rates and content consumption patterns of the identified target population. For example, the target profile may be analyzed to identify specific content genres or types that long-term subscribers consume most frequently. For instance, if the target profile indicates that long-term subscribers predominantly watch documentary and news content, the content distribution platform may allocate more resources to acquiring and caching these content types. The prediction process may utilize time series forecasting techniques such as ARIMA (AutoRegressive Integrated Moving Average) or Prophet to project future resource requirements based on historical data and the characteristics of the target population. In some cases, step 305 may include predicting bandwidth requirements for specific geographic regions based on the concentration of target users in those areas. For example, the prediction may be implemented using machine learning regression models that correlate user demographics with bandwidth consumption patterns. Step 305 may include forecasting storage capacity needs for edge servers based on the viewing preferences identified in the target profile, potentially using random forest algorithms to predict which content should be pre-cached at specific network locations. The infrastructure prediction may also extend to computational resources needed for content transcoding, with the target profile informing which resolution and bitrate combinations would be most frequently requested by the identified user population.

A step 306 may include provisioning content distribution infrastructure resources according to the predictions. This step may involve allocating bandwidth, storage capacity, or processing power to support the anticipated needs of the target population. For example, the provisioning process may be implemented using infrastructure-as-code tools such as Terraform or Ansible to automatically adjust cloud resources based on predicted demand. Step 306 may include implementing geographic-specific content caching strategies using content delivery networks or edge computing platforms in regions with high concentrations of predicted long-term subscribers. For instance, step 306 may include deploying edge caching servers in metropolitan areas with dense populations of identified target users. Step 306 may include utilizing elastic computing resources that automatically scale based on real-time demand patterns and predicted usage trends. For example, step 306 may implement auto-scaling groups in cloud environments that adjust server capacity based on projected viewership patterns. In some cases, step 306 may include configuring content delivery networks to prioritize caching of content genres preferred by the identified target user population, potentially reducing bandwidth requirements and improving streaming quality. The provisioning may be executed through application programming interfaces that integrate with cloud service providers to dynamically allocate resources according to geographic distribution of the target user population.

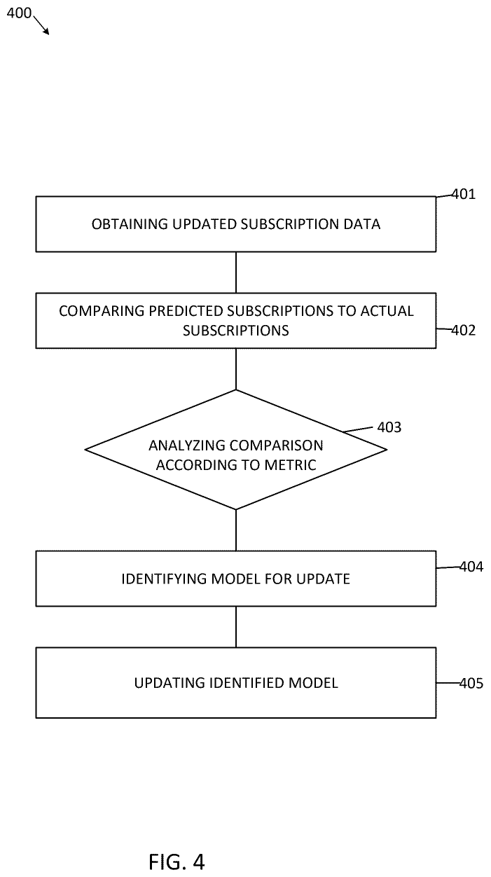

FIG. 4 illustrates a flowchart of a method 400 for updating subscription models. The method 400 may be implemented by the subscriber analysis system 101. The method 400 may be performed by one or more computers executing instructions stored on the non-transitory computer readable medium 103, such as the propensity model generation instructions 106. For example, the processor 102 of the subscriber analysis system 101 may execute instructions to perform the steps of the method 400. The method 400 enables adaptation to changing business conditions, content offerings, and subscriber behaviors.

A step 401 of the method 400 may include obtaining updated subscription data. This step may include retrieving recent user interaction data from the interaction storage system 116 and updated demographic data from the demographic storage system 117. For example, the updated subscription data may include new viewing patterns, content preferences, and engagement metrics collected since the last model update. The step 401 may be implemented using automated data pipelines that extract, transform, and load (ETL) data from various sources into a format suitable for model evaluation and training. The updated subscription data may include information about subscribers who have maintained subscriptions beyond the predetermined time period (e.g., seven months), as well as those who have canceled earlier. This data provides the ground truth for evaluating model performance and identifying potential drift in subscriber behavior patterns. The data collection process may be scheduled to run at regular intervals, such as monthly or quarterly. In some implementations, the step 401 may include prioritizing collection of data about recent content additions or changes to the platform's offerings.

A step 402 may include comparing predicted subscriptions to actual subscriptions. This comparison may include evaluating the performance of both the first propensity model and the second propensity model against real-world outcomes. For example, the step 402 may include calculating metrics such as precision, recall, and F1 score to assess model accuracy. The comparison process may be implemented using confusion matrix analysis, with predicted subscription probabilities thresholded to generate binary predictions for comparison against actual subscription statuses. For the first propensity model, the comparison may focus on how accurately it identified individuals who became subscribers. For the second propensity model, the evaluation may concentrate on how well it predicted which subscribers maintained their subscriptions for the predetermined time period (e.g., seven months or longer). The comparison may also include calculating lift scores, which measure how much better the model performs compared to random selection. For instance, if the baseline subscription rate is 2% and the rate among the top decile of predicted subscribers is 9%, the model would demonstrate a lift of 4.5× for this segment. The step 402 may include tracking these lift scores over time to detect any degradation in model performance. Additionally, the comparison may include evaluating the model's performance across different demographic segments or geographic regions.

A step 403 may include analyzing the comparison according to a metric. This analysis may include calculating specific performance indicators and comparing them to predetermined thresholds. For example, the step 403 may include computing the area under the receiver operating characteristic curve (AUC-ROC) as a comprehensive measure of model performance. The analysis may be implemented using statistical libraries such as SciPy or StatsModels to calculate confidence intervals and perform hypothesis tests on the performance metrics. The step 403 may include tracking multiple metrics simultaneously, including AUC-ROC, precision, recall, F1 score, and lift values. For the first propensity model, a threshold AUC-ROC value of 0.80 might be set, below which the model would be flagged for retraining. For the second propensity model, which predicts long-term subscription behavior, the threshold might be set at 0.75. The step 403 may also include analyzing trends in these metrics over time, looking for consistent declines that might indicate model drift even if absolute thresholds haven't been crossed. For example, if the lift score for the top decile of predictions has decreased by 15% over three consecutive evaluation periods, this might trigger a retraining recommendation even if the absolute lift value remains above a predefined threshold. The analysis may also consider business-specific metrics, such as the cost of customer acquisition versus the predicted lifetime value based on the model's outputs.

A step 404 may include identifying a model for update based on the analysis results. This step may include determining which propensity model, if any, requires retraining based on the performance metrics calculated in step 403. For example, if the AUC-ROC of the first propensity model falls below a threshold of 0.75, it may be flagged for retraining. The identification process may be implemented using a rule-based system that evaluates multiple performance criteria and triggers retraining based on predefined conditions. The step 404 may include prioritizing model updates based on the severity of performance degradation and the business impact of inaccurate predictions. For instance, if both models show some performance decline, but the second propensity model (which predicts long-term subscription behavior) shows a more significant drop, updating that model first might be prioritized. The identification process may also include considering the stability of the model's feature importance rankings. If the relative importance of features has shifted significantly since the last training, this might indicate changes in subscriber behavior patterns that warrant a model update. The step 404 may also include considering external factors, such as the introduction of new content packages, pricing changes, or the entry of new competitors into the market, when deciding whether a model update is necessary.

A step 405 may include updating the identified model. This step may include retraining the selected propensity model using the most current user interaction data and demographic data available. For example, if the first propensity model is identified for update, the step 405 may include retraining the gradient boosted decision tree model with newly available features and target variables. The updating process may be implemented using automated machine learning pipelines that handle data preprocessing, feature engineering, model training, and hyperparameter tuning. The retraining process may include refinement of the feature set, potentially adding new features that have become relevant or removing features that no longer provide predictive value. For instance, the step 405 might include incorporating new engagement metrics such as the ratio of a subscriber's viewing time compared to the average for their demographic segment. The model update may include programmatically configuring different hyperparameter settings. For the gradient boosted decision tree models, this may include adjusting parameters such as the learning rate, maximum tree depth, minimum child weight, and regularization settings. For instance, the step 405 may include executing a grid search or Bayesian optimization process to explore the hyperparameter space. After retraining, the updated model may be validated using a holdout dataset that wasn't used during the training process. The step 405 may also include implementing A/B testing, where a portion of new predictions are made using the updated model while others continue to use the previous version.

The method 400 may include monitoring performance metrics of the first propensity model and the second propensity model over time. This ongoing monitoring process may include regularly calculating key performance indicators such as AUC-ROC, precision-recall curves, and lift scores. For example, the monitoring may be implemented using a time series database to store historical performance metrics. For instance, the method may include performing trend analysis and anomaly detection. The monitoring process may include tracking both absolute performance values and relative changes over time. The monitoring process may include segmented analysis, evaluating model performance across different demographic groups, geographic regions, or content preference segments. The method may include monitoring the distribution of model inputs over time to detect concept drift, where the statistical properties of the input data change in ways that might affect model performance. The method may include generating regular reports summarizing model performance and highlighting any areas of concern.

In some cases, the method 400 may include detecting when a performance metric falls below a predetermined threshold. This detection may trigger automated alerts or model retraining processes. For example, if the lift score of the second propensity model drops below 1.5 for three consecutive evaluation periods, an alert may be generated. The detection process may be implemented using statistical process control techniques, such as cumulative sum (CUSUM) charts, to identify significant deviations from expected performance levels. The method may include implementing different thresholds for different metrics, reflecting their relative importance and typical variability. For instance, a 15% decrease in the AUC-ROC might trigger an alert, while smaller fluctuations would be considered normal variation. The threshold detection may include both absolute thresholds (e.g., AUC-ROC<0.75) and relative thresholds (e.g., 15% decrease from baseline performance). The method may also include implementing trend-based alerts that trigger when a metric shows consistent degradation over multiple evaluation periods, even if absolute thresholds haven't been crossed. The detection process may include prioritizing alerts based on business impact, giving higher priority to issues with the second propensity model (which predicts long-term subscription behavior). The method may include generating detailed diagnostic information responsive to a threshold violation being detected.

The method 400 may include automatically retraining at least one of the first propensity model or the second propensity model using updated user interaction data and demographic data in response to the detected performance degradation. For example, the retraining may be triggered when the AUC-ROC of either model falls below 0.8 for two consecutive months. The automated retraining process may be implemented using containerized machine learning workflows that can be easily deployed and scaled in cloud environments. The retraining process may include feature engineering refinements, potentially incorporating new derived features that better capture evolving subscriber behaviors. For instance, the method might include creating new engagement score metrics that compare individual viewing patterns against platform-wide averages for specific time periods. The automated retraining may include hyperparameter optimization. This optimization may use techniques such as Bayesian optimization to efficiently search the hyperparameter space. The method may include implementing safeguards to prevent problematic model updates, such as validation against multiple performance metrics and comparison with the previous model version. If the retrained model doesn't show improvement across key metrics, the method may include reverting to the previous version and flagging the issue for human review. The automated retraining process may include documentation generation, recording the conditions that triggered the retraining, the changes made to the model, and the resulting performance improvements.

In some cases, the method 400 may include detecting a change in content offerings of the content distribution platform. This detection may include monitoring for significant additions or removals of content categories, channels, or programming types. For example, if a new sports package is introduced, it may be flagged as a potential trigger for model reevaluation. The content change detection may be implemented using natural language processing techniques to analyze content metadata and identify substantial shifts in the platform's offerings. The method may include tracking changes to the content catalog, such as the addition of new channels, the introduction of exclusive content, or the removal of previously available programming. The detection process may include categorizing content changes based on their potential impact on subscriber behavior. For instance, the addition of a major sports package might be flagged as a high-impact change that warrants immediate model reevaluation, while minor content additions might be noted but not trigger automatic retraining. The method may also include monitoring changes to the platform's pricing structure, subscription tiers, or promotional offerings. For example, the introduction of a new lower-priced tier might attract a different demographic profile of subscribers, potentially changing the relationships between demographic features and subscription behavior. When significant content or business changes are detected, the method may include automatically generating a report analyzing the potential impact on model performance and recommending whether model retraining is necessary.

The method 400 may include generating a dashboard displaying current performance metrics of the first propensity model and the second propensity model. For example, the dashboard may include line charts showing AUC-ROC trends, bar charts comparing lift scores across different subscriber segments, and heatmaps visualizing feature importance. The dashboard may be implemented using interactive data visualization libraries such as D3.js or Plotly. The dashboard may include both high-level summary metrics and detailed breakdowns of performance across different subscriber segments or geographic regions. The visualization may include comparative views showing how model performance has changed over time. For instance, a line chart might show the lift score for the top decile of predictions over the past 12 months. The dashboard may include visualizations of feature importance, showing which attributes have the strongest influence on model predictions and how these relationships have evolved over time. The method may include implementing role-based access to the dashboard, providing different views and levels of detail based on user roles.

In some cases, the method 400 may include obtaining user input indicating a retraining decision based on the dashboard. This step may allow human experts to review model performance and make informed decisions about when to retrain. For example, a data scientist may decide to retrain the second propensity model after observing a consistent downward trend in its precision metric, even if it hasn't yet crossed an automatic retraining threshold. The user input process may be implemented as a web-based interface that integrates with the dashboard. The interface may include options for configuring the retraining process, such as selecting which features to include, specifying hyperparameter ranges to explore, or defining validation criteria. The method may include implementing approval workflows for model updates, requiring review and sign-off from designated stakeholders before a retrained model is deployed to production. The user interface may include a simulation capability that allows users to estimate the impact of model retraining on business metrics such as customer acquisition costs, retention rates, or resource allocation efficiency. The method may include maintaining a history of user-initiated retraining decisions, recording the conditions that prompted the retraining, the changes made to the model, and the resulting performance improvements.

The method 400 may include retraining at least one of the first propensity model or the second propensity model using new data, such as current user interaction data, updated demographic data, different user interaction or demographic data fields than were used in the prior training, etc. For example, the retraining may include updating the feature set to include new engagement metrics or content categories that have become relevant since the last training. The retraining process may be implemented using distributed computing frameworks such as Apache Spark. The retraining may include feature refinement based on the latest understanding of subscriber behavior. For instance, the method might include creating new engagement score metrics that compare individual viewing patterns against platform-wide averages for specific time periods. The process may include experimentation with different model architectures or algorithms to determine whether the current approach (gradient boosted decision trees) remains optimal or if alternative approaches might yield better performance. This experimentation may include testing ensemble methods that combine multiple model types. The retraining process may include implementing cross-validation techniques. For example, the method might use k-fold cross-validation with k=5 to assess model stability and performance across different data partitions. After retraining, the method may include conducting a comprehensive evaluation comparing the new model against the previous version across multiple performance metrics and subscriber segments.

By implementing the method 400, the content distribution system 100 may maintain the accuracy and relevance of its propensity models over time. This adaptive approach allows the method 400 to respond to changing subscriber behaviors, content offerings, and market conditions. The combination of automated triggers and human oversight provides a balanced approach to model maintenance. The systematic documentation of model changes and performance metrics creates an auditable history of model evolution. The integration of business context into the retraining decision process ensures that model updates are aligned with organizational objectives and priorities. Overall, the method 400 establishes a framework for maintaining and improving the propensity models that drive the content distribution system's customer acquisition and retention strategies.

FIGS. 5A-5E illustrate examples of outputs from a Shapley (SHAP) analysis, which may be used to interpret the propensity models described in FIGS. 2-4. These graphs provide insights into the relationships between various model features and their corresponding SHAP values, helping to identify and rank influential features for predicting long-term subscribers.

FIG. 5A shows the relationship between household income and SHAP value. The graph may display a generally increasing trend that plateaus at higher income levels. This visualization may help in understanding how income impacts the likelihood of long-term subscription. For example, the analysis might reveal that subscribers with household incomes above $75,000 have consistently positive SHAP values, indicating a higher probability of maintaining a long-term subscription.

FIG. 5B illustrates the relationship between age and SHAP value. The graph may show a curved relationship that peaks in middle age ranges. This information may be valuable for identifying age groups most likely to become long-term subscribers. For instance, the analysis might show that subscribers aged 35-55 have the highest positive SHAP values, suggesting they are more likely to maintain subscriptions for extended periods.

FIG. 5C demonstrates the relationship between household size and SHAP value. The graph may display an increasing trend that levels off at larger household sizes. This visualization may provide insights into how family composition affects subscription behavior. For example, the analysis might reveal that households with 3-4 members have the highest positive SHAP values, indicating a greater likelihood of long-term subscription.

FIG. 5D presents SHAP values across different home ownership categories. The graph may show distinct variations between owner types, such as renters, homeowners with mortgages, and outright homeowners. This information may be used to refine targeting strategies based on housing status. For instance, the analysis might show that homeowners with mortgages have consistently higher positive SHAP values compared to renters, suggesting they are more likely to maintain long-term subscriptions.

FIG. 5E displays SHAP values across different location-based segments, showing varying impacts across different geographic categories. This visualization may help in understanding how geographic factors influence subscription behavior. For example, the analysis might reveal that subscribers in suburban areas have higher positive SHAP values compared to those in urban or rural locations, indicating a greater propensity for long-term subscriptions in these areas.

The SHAP analysis visualized in FIGS. 5A-5E may be used to identify and rank influential features of the second propensity model, as described in the methods of FIGS. 2-4. By examining the magnitude and direction of SHAP values for each feature, the system may determine which attributes have the strongest impact on predicting long-term subscribers. For instance, features with consistently high absolute SHAP values across different segments of the subscriber population may be considered highly influential.

Once influential features are identified and ranked based on their SHAP values, a subset of these features may be selected for use in generating the target user population. This selection process may involve choosing a specific number of top-ranked features or using a threshold based on the magnitude of SHAP values. For example, the system might select the top 20 features with the highest mean absolute SHAP values or choose all features with mean absolute SHAP values above a certain threshold.

The selected subset of influential features may then be applied to a potential subscriber population to generate the target user population. This process may involve using the feature values and their corresponding SHAP impacts to score potential subscribers and identify those most likely to become long-term subscribers. For example, the system might calculate a composite score for each potential subscriber based on their values for the selected features, weighted by the features' SHAP importance.

In some cases, the SHAP analysis may reveal non-linear relationships between features and their impact on predictions. For instance, FIG. 5A might show that income has a positive impact on subscription likelihood up to a certain point, after which the effect plateaus. This information may be used to refine the feature engineering process or to create more nuanced targeting strategies that account for these non-linear effects.

The SHAP analysis may also help identify interaction effects between features. For example, the system might discover that the impact of age on subscription likelihood varies depending on household income levels. These insights may be used to create more sophisticated targeting models that account for complex feature interactions.

By leveraging the insights provided by the SHAP analysis visualized in FIGS. 5A-5E, the content distribution system may refine its propensity models and improve its ability to identify and target potential long-term subscribers. This approach may lead to more efficient resource allocation and enhanced stability of the platform. For example, by focusing marketing efforts on users with feature profiles associated with high positive SHAP values, the platform may reduce customer acquisition costs and improve overall profitability.

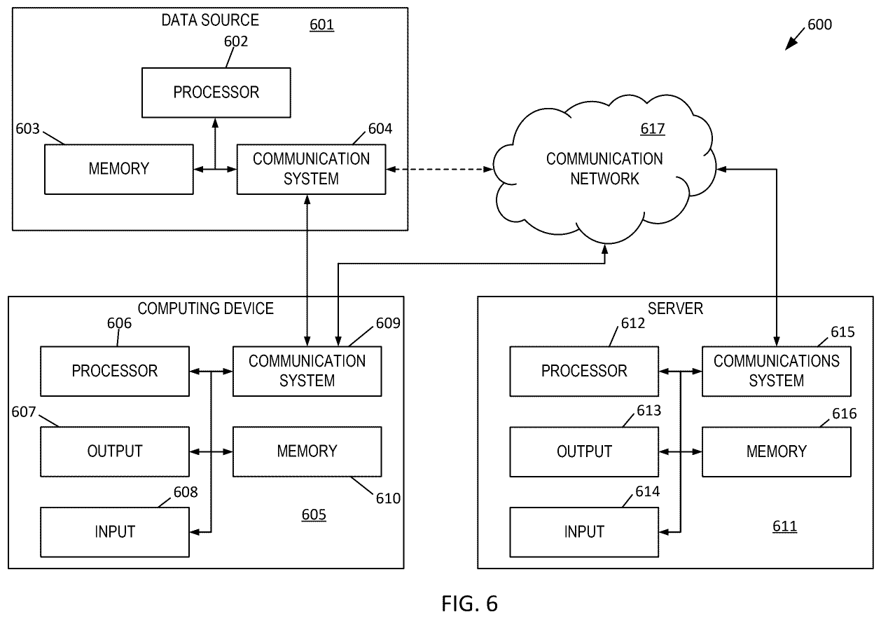

FIG. 6 illustrates a block diagram of a system 600. The system 600 may include a data source 601, a computing device 605, and a server 611 interconnected through a communication network 617.

The data source 601 may include a processor 602, memory 603, and a communication system 604. The processor 602 may connect to both the memory 603 and communication system 604, allowing for processing and transmission of data through the communication network 617. For example, the data source 601 may be implemented as a content delivery network (CDN) origin server that stores and distributes media content to edge servers based on geographic demand patterns. The data source 601 may correspond to one or more of the content storage system 115, interaction storage system 116, and demographic storage system 117 shown in FIG. 1. For instance, when implemented as the content storage system 115, the data source 601 may store media files and associated metadata for distribution to subscribers. When implemented as the interaction storage system 116, the data source 601 may store user interaction data including viewing duration, content selection patterns, viewing time distributions, and device type usage patterns. When implemented as the demographic storage system 117, the data source 601 may store demographic information such as age distributions, income levels, geographic location information, household composition details, and home ownership status. The processor 602 may execute content management systems that organize media assets and their associated metadata, data processing pipelines for interaction data, or demographic data enrichment procedures depending on which storage system is being implemented.

The computing device 605 may comprise a processor 606, an output device 607, an input device 608, a communication system 609, and memory 610. The processor 606 may connect to the output device 607, input device 608, communication system 609, and memory 610, enabling data processing and user interaction capabilities. The communication system 609 may facilitate connection to the communication network 617. For instance, the computing device 605 may be implemented as a streaming media player, smart television, mobile device, or other client device used by subscribers to access content from the distribution platform. For example, the computing device 605 may be implemented as a workstation used by content distribution platform personnel to configure propensity models, adjust model parameters, or view dashboards displaying model performance metrics. The computing device 605 may utilize data visualization libraries such as D3.js or Plotly to render interactive charts showing subscription prediction accuracy over time. In some cases, the computing device 605 may implement a web-based interface that allows marketing analysts to explore feature importance rankings from the Shapley analysis and make informed decisions about targeting strategies based on the identified influential features.

The server 611 may contain a processor 612, an output device 613, an input device 614, a communications system 615, and memory 616. The processor 612 may connect to the output device 613, input device 614, communications system 615, and memory 616. The communications system 615 may enable the server 611 to communicate through the communication network 617. The server 611 may perform propensity model generation, feature identification, target profile creation, and infrastructure resource provisioning based on predicted subscriber behavior. For example, the server 611 may implement gradient boosted decision tree models to predict which potential subscribers are likely to maintain subscriptions for the predetermined time period of seven months or longer.

The communication network 617 may provide connectivity between the data source 601, computing device 605, and server 611, allowing for data exchange between these components. The network 617 may facilitate transmission of user interaction data, demographic information, and content delivery. For instance, the communication network 617 may implement adaptive bitrate streaming protocols that optimize content delivery based on network conditions and device capabilities, with resource allocation prioritized for geographic regions containing high concentrations of predicted long-term subscribers.

The system 600 may be analogous to components described in FIG. 1. For example, the data source 601 may correspond to the content storage system 115, interaction storage system 116, and demographic storage system 117 shown in FIG. 1. These storage systems may provide the content files, user interaction data, and demographic information needed for subscriber analysis and propensity model training.

The computing device 605 may be similar to the first client device 112, second client device 113, or third client device 114 described in FIG. 1. These devices may be used by subscribers to access streaming content and generate user interaction data, which may be crucial for training the first and second propensity models to identify potential long-term subscribers.

The server 611 may be analogous to the subscriber analysis system 101 shown in FIG. 1. The server 611 may execute the various instructions stored in the non-transitory computer readable medium 103, such as the user interaction data instructions 104, demographic data instructions 105, propensity model generation instructions 106, feature identification instructions 107, profile generation instructions 108, and population identification instructions 109.

The communication network 617 may correspond to the communication network 111 in FIG. 1, facilitating data exchange between all components of the content distribution system 100. For example, the communication network 617 may implement content delivery network architectures that strategically place edge servers in regions with high concentrations of predicted long-term subscribers to reduce latency and improve streaming quality.

In some cases, the processor 602 of the data source 601 may execute content management systems that organize media assets and their associated metadata. The memory 603 may be implemented using distributed storage technologies that replicate content across multiple geographic locations based on predicted demand patterns from the propensity models. The communication system 604 may utilize content delivery protocols optimized for efficient streaming media distribution.

The processor 606 of the computing device 605 may support hardware-accelerated video decoding for efficient playback of streaming content. The output device 607 may include displays capable of rendering high-definition or 4K video content. The input device 608 may incorporate remote controls, touchscreens, or voice recognition systems for content navigation and selection. The memory 610 may include local caching capabilities to temporarily store frequently accessed content and reduce bandwidth requirements.

The processor 612 of the server 611 may be optimized for machine learning workloads, particularly gradient boosted decision tree algorithms used in the propensity models. The output device 613 may include dashboards for visualizing model performance metrics and subscriber retention patterns. The input device 614 may consist of data pipelines that ingest and process user interaction data and demographic information. The memory 616 may store trained propensity models, feature importance rankings, and target user profiles generated through Shapley analysis.

By leveraging these specific technologies and implementations, the system 600 may efficiently identify potential long-term subscribers and optimize content distribution infrastructure accordingly. The propensity models can predict which users are likely to maintain subscriptions beyond the seven-month profitability threshold, enabling more targeted marketing efforts and more efficient resource allocation. This approach helps address the technical challenges related to subscriber churn in content distribution platforms, improving overall system efficiency and service quality.

As used herein in the context of computer implementation, unless otherwise specified or limited, the terms “component,” “system,” “module,” “framework,” “engine,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

A number of implementations have been described. Nevertheless, it will be understood that various modifications may be made without departing from the spirit and scope of the disclosure. Accordingly, other implementations are within the scope of the following claims.

1. A method, comprising:
obtaining user interaction data associated with a content distribution platform;
obtaining demographic data;
generating a first propensity model based on the user interaction data and the demographic data, wherein the first propensity model predicts a likelihood of subscription to the content distribution platform;
generating a second propensity model based on the user interaction data and the demographic data, wherein the second propensity model predicts a likelihood of subscription to the content distribution platform for a predetermined time period;
identifying influential features of the first propensity model and the second propensity model; and
generating a target user profile based on the identified influential features.

2. The method of claim 1, further comprising:
identifying a target user population based on the target user profile to predict future content distribution platform activity.

3. The method of claim 1, further comprising:
provisioning content distribution infrastructure resources based on the identified target user population, wherein the provisioning includes allocating bandwidth, storage capacity, or processing power to support predicted content consumption patterns of the target user population.

4. The method of claim 1, wherein generating the first propensity model comprises:
training a first decision tree model on a population comprising subscribers and non-subscribers using the obtained demographic data and the obtained user interaction data; and
evaluating model performance by comparing predicted subscribers against actual subscribers in a validation dataset.

5. The method of claim 4, wherein generating the second propensity model comprises:
training a second decision tree model on the obtained user interaction data and the obtained demographic data, wherein the obtained user interaction data includes content viewing patterns; and
evaluating model performance by comparing predicted long-term subscribers against actual long-term subscribers in a validation dataset.

6. The method of claim 5, further comprising:
analyzing the second propensity model to identify influential features based on their impact on predicting long-term subscribers;
ranking the identified influential features;
selecting a subset of the ranked influential features; and
generating the target user population by applying the selected subset of influential features to a potential subscriber population.

7. The method of claim 6, wherein analyzing influential features of the second propensity model comprises:
generating Shapley Additive Explanations (SHAP) values for features of the second propensity model to identify influential features.

8. The method of claim 5, wherein the first decision tree model and the second decision tree model are gradient boosted decision tree models, and wherein generating the first propensity model and the second propensity model further comprises:
iteratively training multiple decision trees to correct errors of previous trees;
combining predictions from the multiple decision trees to form ensemble models; and
optimizing the ensemble models using a gradient descent algorithm to minimize a loss function.

9. The method of claim 1, further comprising:
monitoring performance metrics of the first propensity model and the second propensity model over time;
detecting when a performance metric falls below a predetermined threshold; and
automatically retraining at least one of the first propensity model or the second propensity model using updated user interaction data and demographic data in response to the detected performance degradation.

10. The method of claim 1, further comprising:
detecting a change in content offerings of the content distribution platform;
generating a dashboard displaying current performance metrics of the first propensity model and the second propensity model;
obtaining user input indicating a retraining decision based on the dashboard; and
retraining at least one of the first propensity model or the second propensity model using current user interaction data.

11. A system, comprising:
a processor; and
a non-transitory computer readable medium storing instructions that, when executed, cause the system to:
obtain user interaction data associated with a content distribution platform;
obtain demographic data;
generate a first propensity model based on the user interaction data and the demographic data, wherein the first propensity model predicts a likelihood of subscription to the content distribution platform;
generate a second propensity model based on the user interaction data and the demographic data, wherein the second propensity model predicts a likelihood of subscription to the content distribution platform for a predetermined time period;
identify influential features of the first propensity model and the second propensity model;
generate a target user profile based on the identified influential features; and
identify a target user population based on the target user profile to predict future content distribution platform activity.

12. The system of claim 11, wherein generating the first propensity model comprises:
training a first decision tree model on a population comprising subscribers and non-subscribers using the obtained demographic data and the obtained user interaction data; and
evaluating model performance by comparing predicted subscribers against actual subscribers in a validation dataset.

13. The system of claim 12, wherein generating the second propensity model comprises:
training a second decision tree model on the obtained user interaction data and the obtained demographic data, wherein the obtained user interaction data includes content viewing patterns; and
evaluating model performance by comparing predicted long-term subscribers against actual long-term subscribers in a validation dataset.

14. The system of claim 13, wherein the instructions, when executed, further cause the system to:
analyze the second propensity model to identify influential features based on their impact on predicting long-term subscribers;
rank the identified influential features;
select a subset of the ranked influential features; and
generate the target user population by applying the selected subset of influential features to a potential subscriber population.

15. The system of claim 14, wherein analyzing influential features of the second propensity model comprises:
generating Shapley Additive Explanations (SHAP) values for features of the second propensity model to identify influential features.

16. The system of claim 13, wherein the first decision tree model and the second decision tree model are gradient boosted decision tree models, and wherein generating the first propensity model and the second propensity model further comprises:
iteratively training multiple decision trees to correct errors of previous trees;
combining predictions from the multiple decision trees to form ensemble models; and
optimizing the ensemble models using a gradient descent algorithm to minimize a loss function.

17. The system of claim 11, wherein the instructions, when executed, further cause the system to:
monitor performance metrics of the first propensity model and the second propensity model over time;
detect when a performance metric falls below a predetermined threshold; and
automatically retrain at least one of the first propensity model or the second propensity model using updated user interaction data and demographic data in response to the detected performance degradation.

18. The system of claim 11, wherein the instructions, when executed, further cause the system to:
detect a change in content offerings of the content distribution platform;
generate a dashboard displaying current performance metrics of the first propensity model and the second propensity model;
obtain user input indicating a retraining decision based on the dashboard; and
retrain at least one of the first propensity model or the second propensity model using current user interaction data.

19. A non-transitory computer-readable medium storing instructions that are executable to:
obtain user interaction data associated with a content distribution platform;
obtain demographic data;
generate a first propensity model based on the user interaction data and the demographic data, wherein the first propensity model predicts a likelihood of subscription to the content distribution platform;
generate a second propensity model based on the user interaction data and the demographic data, wherein the second propensity model predicts a likelihood of subscription to the content distribution platform for a predetermined time period;
identify influential features of the first propensity model and the second propensity model; and
generate a target user profile based on the identified influential features.

20. The non-transitory computer-readable medium of claim 19, wherein generating the first propensity model comprises:
training a first decision tree model on a population comprising subscribers and non-subscribers using the obtained demographic data and the obtained user interaction data; and
evaluating model performance by comparing predicted subscribers against actual subscribers in a validation dataset,
wherein generating the second propensity model comprises:
training a second decision tree model on the obtained user interaction data and the obtained demographic data, wherein the obtained user interaction data includes content viewing patterns; and
evaluating model performance by comparing predicted long-term subscribers against actual long-term subscribers in a validation dataset.
